(19) United States
(12) Patent Application Publication
(10) Pub. No.: US 2026/0117925 A1
(43) Pub. Date: Apr. 30, 2026

(54) INTRINSICALLY SAFE SINGLE-POINT LUBRICATOR

(71) Applicant: AKTIEBOLAGET SKF, GOTEBORG (SE)

(72) Inventors: Xuejun WEN, Shanghai (CN); Jinbao ZHANG, Kunshan (CN); Liyao GUO, Shanghai (CN); Qin HAN, Shangai (CN); Kai GU, Shanghai (CN)

(21) Appl. No.: 19/365,306

(22) Filed: Oct. 22, 2025

(30) Foreign Application Priority Data
Oct. 29, 2024 (CN) 202422612000.9

(51) Int. Cl. F16N 7/38

(52) U.S. Cl. CPC F16N 7/38

(57) ABSTRACT

An intrinsically safe single-point lubricator includes a reservoir unit configured to store a lubricant, a pumping mechanism in the reservoir unit, and a drive unit housing an electric motor and a battery pack and being detachably connected to the reservoir unit and configured to drive the pumping mechanism to force the lubricant out of a lubricant outlet in the reservoir unit. The reservoir unit and/or the drive unit is at least partially coated with an antistatic coating which may be a static dissipative material

### CROSS-REFERENCE

This application claims priority to Chinese patent application no. 202422612000.9 filed on Oct. 29, 2024, the contents of which are fully incorporated herein by reference.

### TECHNOLOGICAL FIELD

The present disclosure relates to a single-point lubricator, especially an intrinsically safe single-point lubricator used in flammable environments such as mines or the like.

### BACKGROUND

A single-point lubricator is designed to automatically deliver a correct dose of a lubricant (lubricating grease or lubricating oil) onto a given lubrication point. The single-point lubricator can more accurately control the supply quantity and supply time of the lubricant as compared to traditional manual lubrication techniques. Since the single-point lubricator comprises an electric motor for driving a pumping mechanism and a battery pack providing power to the electric motor, it must meet the standards of intrinsically safe electrical appliances so as to be used in flammable environments such as mines or the like. The phrase “intrinsically safe” refers to production equipment having sufficient safety through means such as design or the like, so that it will not cause safety accidents in the case of mis-operation or malfunction. The characteristic of intrinsically safe electrical appliances is that all circuits thereof, including the charge release circuit formed by electrostatic charge flowing over a surface of the lubricator, are intrinsically safe. For example, when the lubricator comes into contact with an object (such as the human body or a microcircuit) with different potentials, the electrostatic potential difference will be released by a way of arc or spark discharge. Under normal operation or the specified condition, the electrical sparks and thermal effect generated by this discharge phenomenon each should not ignite specified explosive mixtures.

Reality calls for an intrinsically safe single-point lubricator that can meet the requirements of intrinsically safe electrical appliances in terms of static protection and thus is suitable for operating in explosive environments.

### SUMMARY

In order to meet the above requirements, the present disclosure provides an intrinsically safe single-point lubricator comprising a drive unit for accommodating power components and a reservoir unit for storing a lubricant. The drive unit and the reservoir unit are configured to be assembled together in a detachable manner. The power components comprise an electric motor and a battery pack providing power to the electric motor. The electric motor is provided to drive a pumping mechanism to squeeze the lubricant in the reservoir unit out of an oil outlet. The single-point lubricator has an antistatic coating, especially an electrostatic dissipative coating, at least locally provided on its surface.

The electrostatic dissipative coating can also provide a relatively slow electrostatic discharge in a controlled manner (ranging from one hundredth of a second to several seconds) while inhibiting the formation of initial electrostatic charges and preventing an accumulation of static electricity, thereby effectively preventing any arcs or sparks generated by the contact discharge from igniting flammable gases, liquids or solids in surrounding environment.

Detailed embodiments of the present disclosure and beneficial technical effects thereof are described in detail below in conjunction with the accompanying drawings.

### BRIEF DESCRIPTION OF THE DRAWINGS

FIG. 1A is a sectional elevation view of a drive unit according to an embodiment of the present disclosure.

FIG. 1B is a sectional plan view of the drive unit in FIG. 1A.

FIG. 2A is a sectional elevation view of a reservoir unit that shows an internal structure thereof.

FIG. 2B shows an elevational view of the reservoir unit.

FIG. 3 is a side elevational view of a single-point lubricator formed from the drive unit of FIG. 1A and the reservoir of FIG. 2A.

### DETAILED DESCRIPTION

In the following description, identical or similar reference numerals are always used to denote the same or similar components. Terms indicating directions, for example, “axial”, “radial” and “circumferential (direction)”, refer to the axial, radial and circumferential (direction) of the component being described, unless otherwise defined or specified.

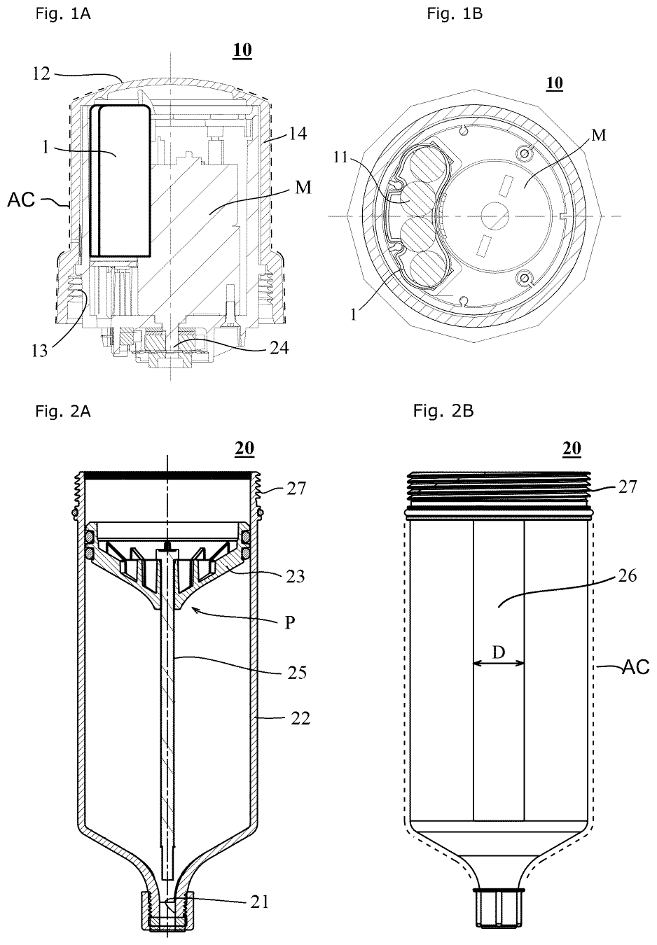

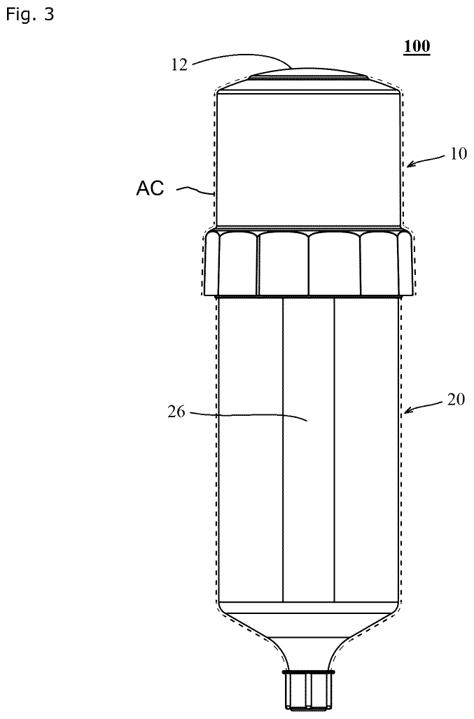

FIG. 1A, FIG. 1B, FIG. 2A, and FIG. 2B show structural schematic views of a drive unit and a reservoir unit in different perspectives. It can be seen from the figures that, a single-point lubricator 100 comprises a drive unit 10 and a reservoir unit 20 that can be assembled together in a detachable manner as shown in FIG. 3. The drive unit 10 is used to accommodate power components such as an electric motor M and a battery pack 11, and the reservoir unit 20 is used to store a lubricant (lubricating grease or lubricating oil). Using the power provided by the battery pack 11, the electric motor M drives a pumping mechanism P to squeeze the lubricant in the reservoir unit 20 out of an oil outlet 21.

The detachable connection between the drive unit 10 and the reservoir unit 20 is achieved by a threaded fit by a housing inner thread 13 of the drive unit 10 and a housing outer thread 27 of the reservoir unit 20. In addition to the connection function, a housing 14 of the drive unit 10 is also configured to press the battery pack 11 against inside a battery compartment 1 using a pressure generated by the threaded fit in order to ensure a reliable electrical connection between a voltage output terminal (usually acted by an output electrode of a battery, not shown) of the battery pack 11 and a voltage input terminal (not shown) of a working circuit of the drive unit 10. Generally, the voltage input terminal of the drive unit 10 is designed to form an electrical connection with the voltage output terminal of the battery pack 11, and the voltage input terminal is mostly formed at the bottom of the battery compartment 1. Based on the above structure, after the battery pack 11 is correctly assembled into the battery compartment 1, the voltage input terminal can rely on the pressure to form a reliable electrical connection with the voltage output terminal of the battery pack 11.

As shown in FIG. 2A, the pumping mechanism P comprises a hydraulic cylinder formed by a cylindrical side wall 22 of the reservoir unit 20 and a piston 23 forming a sliding sealing fit with the hydraulic cylinder (i.e., the cylindrical side wall 22). The output torque of the electric motor M is transmitted to a lead screw 25 through a rotating shaft 24, and then the lead screw 25 converts the output torque into the power for the piston 23 propelling along a straight line inside the reservoir unit 20 through the threaded fit with the piston 23. Based on the above power transmission, the electric motor M finally drives the piston 23 to squeeze the lubricant in the reservoir unit 20 out of the oil outlet 21 below.

When the pumping mechanism P is working, it may generate triboelectric charges due to agitation and squeezing of the lubricant, these triboelectric charges will gather on the surface of the single-point lubricator 100 to form an electrostatic accumulation. When conductors (e.g., the human body or microcircuits) with different potentials come into contact with the lubricator, the accumulated electrostatic charges may be released in a form of an arc or a spark discharge. This discharge is quite dangerous in environments containing flammable gases, liquids or solids (e.g., mines and operating rooms).

For this purpose, the lubricator of the present disclosure has an antistatic coating AC at least locally formed on its surface. The distributions of the antistatic coating AC on the surface of the lubricator are indicated with dotted lines in FIG. 1A, FIG. 2B and FIG. 3, respectively. The antistatic coating is made of electrostatic dissipative materials (abbreviated as “dissipative materials”) capable of slowly releasing static electricity, and the surface resistivity of the dissipative materials is between 104-1011 ohms/square. Compared with conductive materials that can also be used for antistatic (surface resistivity less than 104 ohms/square), the dissipative materials have weaker conductivity and allow current to flow slower, so that the time required for the charges to be shared by the conductor or be neutralized is longer, making it difficult to form arc or spark discharge. As one preferred embodiment, the surface resistance of the antistatic coating does not exceed 1 GQ, which may be formed by spraying epoxy resin self-drying low-resistance semiconductor paint.

FIG. 3 is a schematic diagram of the overall structure of the lubricator. It can be seen from the figure that, a portion of the surface of the lubricator that is not covered by an antistatic coating AC is formed with transparent windows, comprising a first window 12 formed at the axial top of the drive unit 10 and a second window 26 formed on the cylindrical side wall 22 of the reservoir unit 20. The first window 12 allows the user to observe working status of the power components inside the drive unit 10, and the second window 26 allows the user to observe the remaining amount of the lubricant inside the reservoir unit 20. However, the above windows must be provided on the premise that they do not hinder the overall working efficiency of the antistatic coating AC on the surface of the lubricator, which mainly depends on the position distribution and area proportion of each window on the drive unit and the reservoir unit.

It can be seen from FIG. 1A that, the first window 12 is provided at the axial top of the drive unit 10, and is a substantially circular or elliptical shape. As a preferred embodiment, a projected area in an axial direction of the first window 12 accounts for 40-50% of the projected area of the top of the drive unit 10. In the preferred embodiment shown in FIG. 2B, the second window 26 extends axially substantially along the cylindrical side wall 22 of the reservoir unit 20, and its circumferential distribution (indicated by width D) accounts for 10-20% of a circumferential length of the cylindrical side wall 22. The shapes and distributions of the above windows are based on the premise that the information of the units is visible, but should not damage the overall working efficiency of the antistatic coating AC.

The intrinsically safe single-point lubricator described above are not limited by the specific embodiments and more general technical solutions will be subject to the limitations of the accompanying claims. Any modifications and improvements to the present disclosure are within the scope of protection of the present disclosure, provided they conform to the limitations of the accompanying claims.

What is claimed is:

1. An intrinsically safe single-point lubricator comprising:
a reservoir unit configured to store a lubricant,
a pumping mechanism in the reservoir unit, and
a drive unit housing an electric motor and a battery pack and being detachably connected to the reservoir unit and configured to drive the pumping mechanism to force the lubricant out of a lubricant outlet in the reservoir unit,
wherein the reservoir unit and/or the drive unit is at least partially coated with an antistatic coating.

2. The single-point lubricator according to claim 1,
wherein the reservoir unit and the drive unit are each at least partially coated with an antistatic coating.

3. The single-point lubricator according to claim 2,
wherein the antistatic coating comprises a static dissipative material.

4. The single-point lubricator according to claim 3,
including a transparent window in the reservoir unit not coated with the antistatic coating and/or a transparent window in the drive unit not coated with the antistatic coating.

5. The single-point lubricator according to claim 3,
including a transparent window in the reservoir unit not coated with the antistatic coating and a transparent window in the drive unit not coated with the antistatic coating,
wherein the transparent window in the reservoir unit is located in a cylindrical side wall of the reservoir unit, and
wherein the transparent window in the drive unit is located on a side of the drive unit opposite from the reservoir unit.

6. The single-point lubricator according to claim 5,
wherein the transparent window in the drive unit is circular or elliptical and has a projected area in an axial direction accounting for 40-50% of a total projected area of the side of the drive unit opposite from the reservoir unit.

7. The single-point lubricator according to claim 6,
wherein the transparent window in the reservoir unit extends axially on the cylindrical side wall of the reservoir unit and has a distribution in a circumferential direction accounting for 10-20% of a circumferential length of the cylindrical side wall.

8. The single-point lubricator according to claim 7,
wherein the reservoir unit includes first screw threads threadedly connected to second screw threads of the drive unit.

9. The single-point lubricator according to claim 8,
wherein the drive unit has a housing configured press the battery pack against an inside portion of a battery compartment via a pressure generated by the first screw threads threadedly connected to second screw threads.

10. The single-point lubricator according to claim 3,
wherein a surface resistivity of the dissipative material is between 104-1011 ohms/square.

11. The single-point lubricator according to claim 3,
wherein the dissipative material comprises epoxy resin self-drying low-resistance semiconductor paint.
